(19) United States
(12) Patent Application Publication
(10) Pub. No.: US 2006/0168827 A1
(43) Pub. Date: Aug. 3, 2006

(54) Method and device for measuring the steering geometry of vehicles

(75) Inventor: Ulrich Roethlisberger, Schachen (CH)

Correspondence Address: DARBY & DARBY P.C., P. O. BOX 5257, NEW YORK, NY, 10150-5257, US

(73) Assignee: LASATRON AG, Wohlhusen (CH)

(21) Appl. No.: 11/335,159

(22) Filed: Jan. 18, 2006

Related U.S. Application Data
(63) Continuation of application No. PCT/CH03/00484, filed on Jul. 18, 2003.

(51) Int. Cl. G01B 5/24

(52) U.S. Cl. 33/203.18

(57) ABSTRACT

A method and device for measuring the geometric data of a rotationally symmetrical body, such as a disc or a wheel which can be rotated about an axis, uses a measuring frame to secure the wheel. A measuring carrier is arranged in front of the wheel and can be supported on the measuring frame. The measuring carrier can be linearly displaced and pivoted in relation to the measuring frame in three axes (x, y, z) and can rotate about an axis of rotation (x). The measuring carrier is aligned with respect to the wheel such that it is centered in relation to the axis of rotation (x). A distance sensor is used to measure the distance (a) between the measuring carrier and the wheel. The sensor is radially displaceable from the axis of rotation (x) of the measuring carrier. Servo motors displace the measuring carrier with respect to the wheel by linear and/or pivotal movements based on the measurements so that the measuring carrier rotates about its axis of rotation (x) in parallel with the body. These movements are detected and recorded by movement sensors, whose outputs are transmitted to an evaluation unit that calculates the geometric data.

### CROSS-REFERENCE TO RELATED APPLICATION

This application is a continuation of International Patent Application Serial No. PCT/CH2003/000484, filed Jul. 18, 2003, which published in German on Jan. 27, 2005 as WO 2005/008172 A1, and is incorporated herein by reference in its entirety.

### BACKGROUND OF THE INVENTION

The present invention relates to a method and device for measuring the geometric data of a rotationally symmetrical body, such as a disc or a wheel which can be rotated about an axis, in relation to a measuring frame and a device.

The steering mechanism enables a wheeled vehicle to execute defined changes in its traveling direction. The steering mechanisms of vehicles having four or possibly more wheels should be constructed or set to ensure that all wheels execute an optimum geometrical rolling motion, particularly when cornering.

In motor cars which are generally constructed as four-wheel vehicles, the steering mechanism is conventionally realized in the form of an axle pivot steering of the front wheels. In this case, each steered wheel—usually the two front wheels—has a separate center of motion. The geometry of this steering mechanism is often designed to be adjustable so that the above requirements can be fulfilled to the greatest extent possible. Adjusting members are then used to adjust the steering geometry according to the design specifications in terms of toe, camber, caster, steering axes inclination (SAI), etc. The same also applies to the, generally unsteered, rear wheels. For practical reasons, these adjustments or the values of the steering geometry are measured by way of the wheels mounted on the chassis.

To this end, for example, adapters are fixed to the wheel by means of clamps or hooks and their relative movements with respect to a fixedly arranged base are detected and evaluated. These systems are highly disadvantageous in that the procedures for assembling and dismantling the adapter on the wheel are very involved, particularly very time-consuming, and are likewise very demanding in terms of the fact that these adapters and measuring devices require precise handling. Since the electronic adapters have highly sensitive sensors inside for measuring the smallest of movements, these can be easily damaged if not handled carefully, which consequently leads to inaccurate results. To prevent these problems and to enable rapid yet reliable measurements to be carried out, particularly when producing new vehicles, non-contact measuring devices are also used. In this case, the sensors of the measuring devices are no longer mounted directly on the wheel, but are arranged outside the wheel in a measuring frame. These non-contact measuring devices conventionally operate using laser triangulation modules, with three mutually distanced modules of this type having to be used for each wheel to detect the angular track and king pin angle values. In a four-wheel vehicle in which these data have to be detected for all wheels, this means using 12 such modules. Measuring devices of this type are therefore very expensive to produce and moreover, due to the nature of the system, only have a limited measuring range in terms of toe and camber pin angle. The accuracy when determining indirect values such as castor angle, steering axes inclination (SAI) and toe difference angle is therefore reduced.

### SUMMARY OF THE INVENTION

The object of the present invention is to find a method and a device which enable rapid, simple and reliable measurement of the steering geometry, e.g., for the automotive industry, using the simplest means possible.

According to the invention, this object is achieved by a method and device including at least one measuring carrier, which is moved linearly in three mutually perpendicular axes, is pivoted about these axes and is arranged on a measuring frame. The measuring carrier can therefore undergo rapid rough alignment with respect to the body to be measured, which is likewise arranged on the measuring frame for measuring purposes. To obtain precise values, the rotational plane of the measuring carrier is now aligned precisely parallel to the rotational plane of the body to be measured. This takes place with the non-contact measurement of the distance between the measuring carrier and the body to be measured, to which end one distance sensor is mounted at at least one point which is radially distanced from the axis of rotation of the measuring carrier. By rotating the measuring carrier, the distance between the sensor and the corresponding circumferential line of the body to be measured is now detected and supplied to an evaluation unit. As a measured variable, it is not the absolute distance which is of interest here, but merely the deviation from the starting value during one revolution. As a result of evaluating these deviations, the measuring carrier can be aligned through linear and/or pivotal movements until the distance remains constant during one revolution. This results in an absolute parallel alignment of the measuring carrier with respect to the body to be measured. By detecting the aligning movements, it is now possible to determine and display and/or store the geometrical values, particularly angular values, with respect to the measuring frame. Since particularly only the deviation of the distance and not the distance as an absolute value is advantageously used, it is possible to use substantially simpler and more favorable sensors by comparison with conventional optical triangulation methods and, in particular, a single sensor is essentially sufficient for the measurement of each body.

Laser sensors, infrared sensors or ultrasound sensors are preferably used for the distance measurement. Since only the change in the distance is of interest for the alignment of the measuring carrier, differential sensors are preferably used, which advantageously deliver an analog output signal.

If a continuous signal, preferably in the form of a surface wave, is now preferably transmitted as a measuring signal, the phase position between the transmission signal and the receiver signal, i.e. between the transmission oscillation and receiver oscillation, can be electronically detected and recorded as a measure of the distance. A change in this phase position then indicates a different distance in each case and the evaluation unit can move the measuring carrier accordingly, i.e. linear displacement or rotation, as a result of these values until virtually no more changes occur, i.e. only changes caused by irregularities in the surface of the body along the measuring region are still detected. The movement of the measuring carrier can be effected by means of conventional servo drives which can be simply controlled by means of the evaluation unit and also allow the finest of movements.

Starting from a defined starting position with respect to the measuring frame, these movements can preferably be measured by means of corresponding sensors, advantageously by means of incremental encoders and analog or incremental angle sensors. This enables the absolute angular values of the measuring carrier with respect to the measuring frame to be determined in a simple manner, with these angular values corresponding to the values of the body to be measured.

In order to adapt the measuring carrier according to the body to be measured, for example to the different dimensions of vehicle wheels, the distance sensor is preferably arranged in the measuring carrier such that it is radially displaceable in relation to the axis of rotation of the measuring carrier. This displacement is preferably effected by means of a cam disc which is likewise controlled by way of the evaluation unit.

So that high forces are not produced during the rotation of the measuring carrier, an additional body serving as a counter-weight is preferably mounted axially symmetrically to the distance sensor. This counter-weight is advantageously at the same radial distance from the axis of rotation of the measuring carrier and is the same weight. The counter-weight is likewise advantageously radially displaceably arranged on the measuring carrier.

Depending on the requirements relating to the measuring speed, it is also possible to arrange a plurality of distance sensors on the measuring carrier. For example, a second distance sensor can be advantageously used as a counter-weight. The measuring speed can therefore be increased with the same rotational movement of the measuring carrier.

According to the invention, the object is further achieved by a device suitable for carrying out the method of the invention. Preferred embodiments according to the invention include having the distance sensor radially displaceably arranged on the carrier plate to set an ideal circumferential region of the body to be measured. When measuring wheels of motor vehicles, the distance sensor is for example advantageously set to the region where the width of the tire is greatest (rubber bead), i.e. the smallest distance in the axial direction of the measuring carrier.

The carrier plate is advantageously constructed in the form of a circular disc in which the distance sensor is arranged on a plate which is radially displaceably guided along guide rails.

Although, according to the invention, the method and device according to the invention are suitable for measuring the steering geometry of vehicle wheels, other applications are also considered within the scope of the invention.

### BRIEF DESCRIPTION OF THE DRAWINGS

Exemplary embodiments of the present inventions are explained in more detail below with reference to drawings, which show:

FIG. 1 a schematic view of the arrangement of a wheel with the virtual measuring plane of a measuring device according to the invention;

FIG. 2 a plan view of a measuring device constructed according to the invention;

FIG. 3 the side view of the measuring device according to FIG. 2;

FIG. 4 a further plan view of the measuring device according FIG. 2 with alternative positions of the measuring head; and

FIG. 5 a plan view of an alternative embodiment of a measuring device according to the invention.

### DETAILED DESCRIPTION OF THE INVENTION

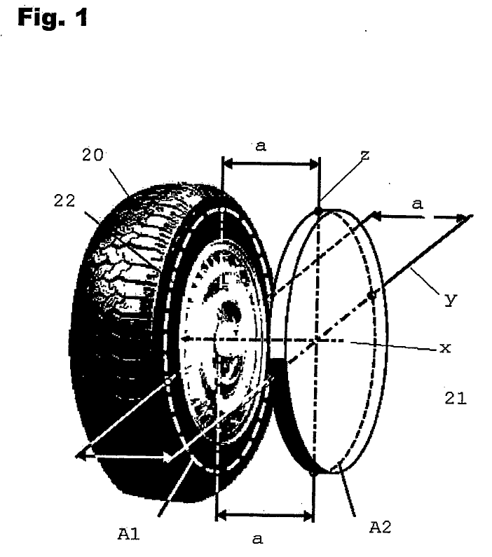

FIG. 1 shows a wheel 20 with a wheel axle 21. The wheel 20 in this illustration is the body to be measured. The wheel may be mounted on a vehicle which has been driven onto a measuring frame, such as those produced by Lasatron AG of Wohlhusen, Switzerland. Such frames allow the wheel to be stationary while the wheel alignment is measured. The invention is thus used in vehicle manufacturing plants, automotive dealerships, garages, tire stores, etc. to test wheel alignment, e.g., toe-in, front and rear wheel camber, castor (inclination of the steering knuckle pivot front), steering angle, steering lock and wheel wobble compensation, etc.

The wheel 20 spans a plane A1 perpendicular to the wheel axle 21. This plane A1 can extend through a concentric circumferential line 22 of the wheel 20 or the tire. A measuring plane A2 is intended to extend at a distance a in front of the plane A1 and is aligned parallel to this plane A1. In order to achieve this position, this measuring plane A2 is displaced linearly along the three axes x, y and z and is also rotated about these axes x, y and z while the body remains stationary. To this end, a sensor is arranged on the measuring plane A2, which detects the distance between the plane A1 and the measuring plane A2. The sensor may be mounted on a measuring robot.

For rough alignment, the movements of the measuring plane A2 can be effected precisely in a known manner, e.g. by means of the optical detection of the edges of the wheel 20 using servo controls, for example electric servo motors. The corresponding linear movements can be detected and measured using movement sensors, such as incremental encoders, and the rotational movements can be detected and measured by of other movement sensors, such as analog or incremental angle sensors. This procedure is carried out until the axes of rotation x of the two planes A1 and A2 are aligned to be centered with respect to one another.

The distance a is further detected for precise parallel alignment of the plane A2. The measurement of the distance is required for controlling the servo control in order to align the plane A2 precisely parallel to the plane A1. To this end, a differential sensor on an optical or acoustic basis is preferably used. Since a large measuring region is not required and, in particular, it is not the absolute distance value which is of interest but merely the deviations or changes in distance which have to be detected, it is possible to consider using relatively economical sensors. It is only necessary for these sensors to be adjusted to a set measurement, for example a zero value at the start of the measurement, and then to detect the deviations from this set measurement which occur during the positioning procedure and transmit them to the control. Therefore, known sensors based on laser, infrared or ultrasound technology are used. A bipolar, analog output is advantageously used as the output signal, which can control the servo drives, for example stepping motors or direct current drives, in very simple manner by way of the evaluation unit.

In a preferred embodiment, the distance between the measuring plane A2 and the plane A1 of the wheel 20 is determined by emitting a continuous surface wave. To this end, the distance sensor has an arrangement of at least two elements, namely a transmitter and a receiver. With a change in the distance between a distance sensor of this type and the wheel 20, or the tire surface, the phase position between the transmission and receiver oscillation also changes periodically. As a result of recording this phase displacement and evaluating the differences which occur, variations in the distance are detected with high precision, thus enabling precise alignment of the measuring plane A2 with respect to the plane A1.

The distance sensor can also have a plurality of receivers and a transmitter for carrying out more precise positioning. It is thus possible, for example, to determine the exact position or shift in position on a tire bead which forms a torus and does not represent a planar face.

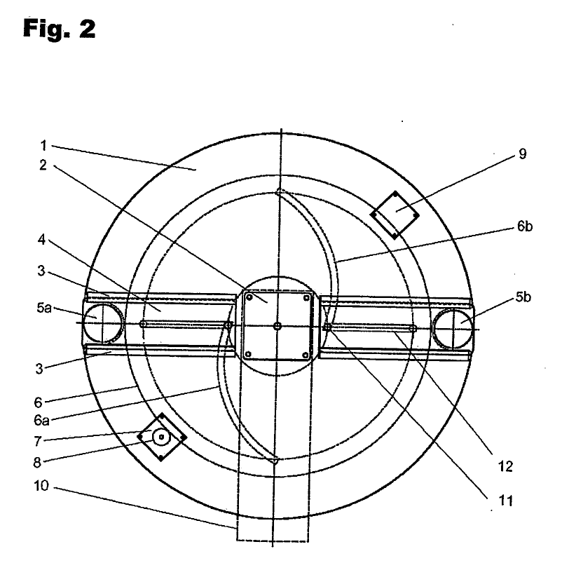

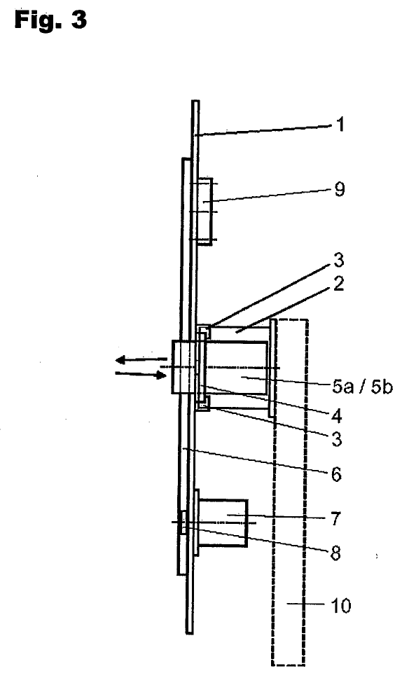

The plan view of a measuring device or robot constructed according to the invention for a wheel is illustrated schematically in FIG. 2 and, in FIG. 3, the side view is also shown for better clarity. This measuring device has a circular carrier plate 1 which can be rotated about its axis of rotation by means of the motor 2.

A sensor 5a is radially displaceably arranged on the carrier plate 1 and is also diametrically opposite a likewise displaceable counter-weight 5b. The sensor 5a and the counter-weight 5b are each fixed to slide plates 4 which are radially displaceably mounted in guide rails 3 arranged on the carrier plate 1.

The radial movement of the slide plates 4 is effected by way of journals 11 arranged on a cam disc 6, which is arranged parallel to the carrier plate 1 and is likewise rotatable about the axis. The journals 11 here engage in a groove 12 in the slide plate 4, said groove being constructed parallel to the guide rails. As a result of a relative rotation between the carrier plate 1 and the cam disc 6, a radial inward or outward displacement of the sensor 5a and the counter-weight 5b is thus effected.

The rotation of the cam disc 6 can be effected by way of a drive motor 7, which engages for example in a gearing constructed on the circumference of the cam disc 6 by way of a pinion 8.

Where possible, the counter-weight 5b should be the same weight as the sensor 5a. The rotation of the carrier plate 1 can thus be effected without a high torque requirement since the moving part of the device is advantageously practically balanced in relation to the axis.

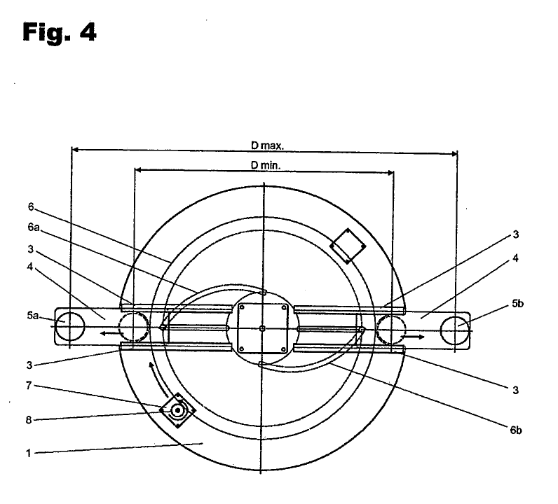

The plan view of a measuring device or robot according to FIG. 1 is again illustrated schematically in FIG. 4, with the sensor 5a and also the counter-weight 5b in the respective maximum radial end position. This position is achieved by driving the drive motor 7 in the direction of the arrow, which consequently results in a relative rotational movement of the cam disc 6 with respect to the carrier plate 1. This enables the measuring device to be used for a large number of different bodies, for example with different wheel dimensions.

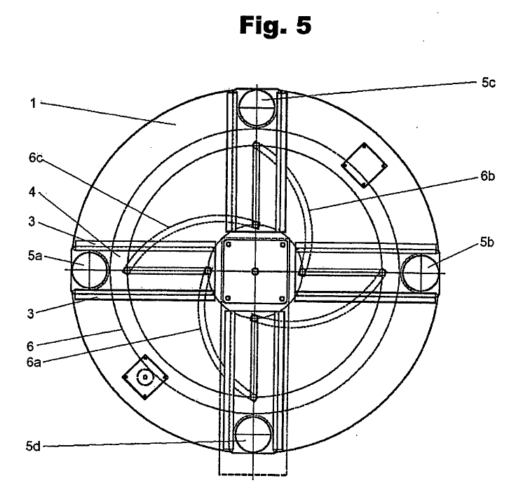

FIG. 5 again shows a plan view of a further embodiment of a measuring device according to the invention. In FIG. 5 sensors 5c and counter-weights 5d are arranged on the carrier plate 1. All sensors 5a, 5c and counter-weights 5b and 5d are advantageously positioned radially together by way of a cam disc 6.

Measuring devices of this type are particularly suitable for measuring the steering geometry of motor vehicles. In a small configuration, two measuring devices of this type are arranged on both sides of a measuring frame, such as those made by Lasatron AG, onto which the vehicle to be measured is driven. The two wheels (front and back) on each vehicle side are tested by a measuring device or robot which is arranged such that it can be displaced in the longitudinal direction along a fixed guide from one wheel to the other wheel. After the measurement of all four wheels, further values such as castor angle, steering angle, steering inclination and toe difference angle can also be calculated in addition to the direct values for toe and camber angle. For particularly efficient and rapid measurement, two measuring devices are advantageously used on each side of the vehicle, i.e. a separate measuring device is used for each wheel. This enables the values to be detected and recorded in very rapid, simple and precise manner.

While the invention has been particularly shown and described with reference to preferred embodiments thereof, it will be understood by those skilled in the art that various changes in form and details may be made therein without departing from the spirit and scope of the invention.

What is claimed is:

1. A method of measuring the geometric data of a rotationally symmetrical body, such as a disc or a wheel which can be rotated about an axis, in relation to a measuring frame, comprising the steps of:
arranging in front of the body a measuring carrier that can be linearly displaced and pivoted in relation to the measuring frame in three axes (x, y, z) and can rotate about an axis of rotation (x);
aligning the measuring carrier with respect to the body such that it is centered in relation to the axis of rotation (x);
measuring with a distance sensor the distance (a) between the measuring carrier and the body from at least one point which is radially distanced from the axis of rotation (x) of the measuring carrier;
displacing the measuring carrier with respect to the body by linear and/or pivotal movement based on measurements from the distance sensor representative of the relative movements of the measuring carrier with respect to the body so that the measuring carrier rotates about its axis of rotation (x) in parallel with the body; and
detecting the relative movements of the measuring carrier with respect to the measuring frame by means of movement sensors; and
sending a detected signal to an evaluation unit to determine the geometric data.

2. A method according to claim 1, wherein the distance sensor is at least one a laser sensor, infrared sensor or ultrasound sensor.

3. A method according to claim 2, wherein the distance sensor is a differential sensor which generates a bipolar, analog output signal.

4. A method according to claim 1 wherein the distance measurement is carried out by means of a continuous surface wave which is emitted by an exciter and which, after reflection against the body is detected by way of a receiver, the phase position between the excitation and receiver oscillation being determined and recorded; and wherein the recorded signal is evaluated in the evaluation means as a measure of the distance or the change in distance and used to control the displacement of the measuring carrier.

5. A method according to claim 1 wherein the linear movements of the measuring carrier are measured by means of incremental encoders.

6. A method according to claim 1 wherein the rotational movements or angles of rotation of the measuring carrier about the three axes (x, y, z) are measured by movement sensors in the form of analog or incremental angle sensors.

7. A method according to claim 1 wherein the distance sensor is arranged in the measuring carrier such that it is radially displaceable in relation to the axis of rotation (x) of the measuring carrier.

8. A method according to claim 7 wherein the distance sensor is displaceable in relation to the axis of rotation (x) of the measuring carrier (1) by means of a cam disc controlled by way of a servo drive.

9. A method according to claim 7, further including the step of adjusting the distance sensor in the measuring carrier to the radius with the smallest axial distance between the distance sensor and the body.

10. A method according to claim 9, wherein the step of adjusting the distance sensor in the measuring carrier is performed automatically using the results of the distance measurement.

11. A method according to claim 1 wherein a counter-weight is arranged on the measuring carrier such that it is axially symmetrical with respect to the distance sensor to reduce the torque required to rotate the carrier.

12. A method according to claim 11 wherein the counter-weight is arranged on the measuring carrier such that it has the same weight as the distance sensor and further including the step of adjusting its distance with respect to the axis of rotation (x) of the measuring carrier such that it is identical to the distance of the distance sensor.

13. A method according to claims 1, further including the step of setting the rotational speed of the measuring carrier according to one of the desired or required regulating time and/or display speed.

14. A method according to claim 1, further including the step of no longer rotating the carrier for further measurements of the same body after the parallel alignment of the measuring carrier.

15. A method according to claim 1 wherein the measuring of the distance from the measuring body to the carrier is performed with at least three mutually distanced distance sensors, and the displacing of the measuring carrier to achieve a parallel adjustment is a result of the evaluation of the measurement of these at least three distance sensors.

16. A device for measuring the geometric data of a rotationally symmetrical body, such as a disc or a wheel which can be rotated, in relation to a measuring frame, comprising:
a measuring carrier plate arranged linearly displaced and pivoted in relation to the measuring frame in three axes (x, y, z) and being rotatable about an axis of rotation (x), said measuring carrier plate being arranged in front of the body and being aligned with respect to the body such that it is centered in relation to the axis of rotation (x);
at least one distance sensor to measure the distance (a) between the measuring carrier plate and the body from at least one point which is radially distanced from the axis of rotation (x) of the measuring carrier plate, said sensor being arranged on the measuring carrier plate such that it is radially displaceable with respect to the axis of rotation (x), said distance sensor having a detecting region which points substantially perpendicularly away from the measuring carrier plate;
a motor unit for displacing the measuring carrier plate with respect to the body by linear and/or pivotal movement based on the measurement of the relative movements of the measuring carrier plate with respect to the body so that the measuring carrier plate rotates about its axis of rotation (x) in parallel with the body;
a movement sensor that detects the relative movements of the measuring carrier with respect to the measuring frame: and
an evaluation unit in which the movement sensor measurements are evaluated to determine the geometric data.

17. A device according to claim 16 further including one of a counter-weight and a further distance sensor are arranged axially symmetrical to each distance sensor such that it is displaceable in such a way that both the distance sensor and the counter-weight or the further distance sensor are each at the same radial distance from the axis of rotation (x) of the measuring carrier plate.

18. A device according to claim 16 or 17, wherein the distance sensor is constructed as one of a laser sensor, infrared sensor and ultrasound sensor.

19. A device according to claim 18 wherein the distance sensor generates a bipolar, analog output signal.

20. A device according to claim 16, wherein the distance sensor has an emitter for emitting a continuous surface wave signal and a receiver for receiving the signal reflected by the body.

21. A device according to claim 16 wherein the measuring carrier plate is connected to the measuring frame by way of the motor unit.

22. A device according to claim 21 wherein the motor unit is a plurality of servo motors, such that the measuring carrier plate is displaceable in three axes, and wherein said movement sensors are arranged for detecting these displacements.

23. A device according to claim 22 wherein the servo motors are stepping motors and the movement sensors arranged for detecting displacements are incremental encoders.

24. A device according to claim 22 wherein the servo motors are present for rotating the measuring carrier plate about at least two axes, and wherein the movement sensors are arranged for detecting these rotations.

25. A device according to claim 24 wherein the movement sensors for detecting the rotations are one of analog and digital angle sensors.

26. A device according to claim 16 wherein the distance sensor is radially displaceable by way of a cam disc, and is constructed such that it is rotatable with respect to said measuring carrier plate by means of a separate drive motor.

27. A device according to claim 26 wherein the cam disc is arranged coaxially to the measuring carrier plate and the separate drive motor is one of a stepping motor and a servo motor.

28. A device according to claim 16 further including a counter-weight radially displaceably arranged on the carrier plate such that it is coaxial with the distance sensor.

29. A device according to claim 28 wherein the counter-weigh has the same weight as the distance sensor.

30. A device according to claim 28, wherein the counter-weight is in the form of a further distance sensor.

31. A device according to claim 16 wherein the measuring carrier plate is coaxially connected to a rotational drive.

32. A device according to claim 31 wherein the rotational drive is an electric drive motor.

33. The method according to claim 1 wherein the geometric data is the steering geometry of a vehicle, preferably a motor car or truck.

34. The device according to claim 16 wherein the geometric data is the steering geometry of a vehicle, preferably a motor car or truck.
